(19) United States
(12) Patent Application Publication
(10) Pub. No.: US 2009/0301665 A1
(43) Pub. Date: Dec. 10, 2009

(54) TEMPORARY DECORABLE WINDOW COVERING

(76) Inventor: Mary Ann Galloway, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/478,521

(22) Filed: Jun. 4, 2009

Related U.S. Application Data
(60) Provisional application No. 61/058,740, filed on Jun. 4, 2008.

(51) Int. Cl. E06B 9/24

(52) U.S. Cl. 160/84.04; 29/592

(57) ABSTRACT

Among other things, there is disclosed temporary, easy to make and decorate coverings for windows and similar purposes. Exemplary coverings are of sturdy paper having a series of vertical folds. An upper portion may be folded to increase strength along a portion where hangers or rods are placed to suspend the covering. The coverings permit easy personalization or other decoration, and are disposable when the user wishes to replace them.

The present disclosure relates in general to temporary window coverings. More particularly, this disclosure relates to window coverings that are inexpensive, easy to put up, and decorable or customizable to the user's decorating taste. This application claims the benefit of U.S. Provisional Application No. 61/058,740, filed Jun. 4, 2008.

### BACKGROUND

When homeowners or renters first move in to a new residence, there are many initial expenses that must be provided for. Certain expenses, such as essential kitchen appliances and furniture, cannot be delayed and often consume a major portion of the homeowner's budget. Another item that tends to be quite expensive is window coverings. Homeowners often choose to delay purchase of the window coverings not only to save on initial expenses, but also so that they may choose the color and style to coordinate with not-yet-purchased furniture or other decor. In addition, parents of small children may choose to wait until the children reach a certain age or maturity level before investing in expensive drapery or other window treatments, which might otherwise be damaged due to day-to-day child play. Renters (including college students) want to avoid spending significant sums on window coverings for lodgings that may be relatively short-term or temporary, and that may not easily fit windows or decor in later homes.

Despite the common choice to delay or avoid purchase of permanent, expensive drapery, residents still desire or require some sort of covering for windows to maintain privacy and shield from external light during the period after moving in but before permanent window coverings (if any) are purchased and installed. Residents often choose to cover the windows with bed linens, newspaper or other available and unused textiles or objects. However, these materials are not aesthetically appropriate. For example, newspaper is inked with text, which generally provides no aesthetic benefit, and advertisements, which may be somewhat bright or flamboyant, or present undesirable images. The ink rubs off onto persons and materials that come in contact with it, and the ink impedes or prohibits personalization through painting, marking or other aesthetic change. Newsprint is also thin, and so substantial light easily passes through. The result is undesirable, with more light than preferred entering the room and highlighting text or images on both sides of the paper. Linens may be in short supply, and if old linens are used as window coverings, then expensive new linens must be purchased for use as linens. Available old linens may be stained, damaged or otherwise unpresentable for display in a publicly-viewable window, and the cloth in such linens are not generally easy to decorate or personalize with paint or stickers in a lasting manner, due to the fluid nature and the weave of the fabric.

These items are also not mechanically practical. Newspaper or linens are not designed to be attached to or hung in front of windows, and thus additional steps or structures are needed to use them in that way. Tape or glues can be used to attach newsprint to a window or to the casing outside the window. However, in addition to potential damage to the window or casing, a substantial amount of tape or glue must be placed in order to avoid having the newsprint come away from the window or uncover a portion of it. The problems of tapes or glues are somewhat greater with respect to linens, as they are heavier and much more likely to sag, droop or fall away from the window. Staples cannot be used in the window itself, and also cause damage to walls or casings, if they can be forced into metal casing edges or wall joists. Even if a curtain rod is already placed above a window and arranged so that newspaper or linens can be draped over them, a double length of newspaper or linen is needed so that the entire window can be covered without a significant disparity in the length extending down from either side of the curtain rod, since such disparities will result in the covering falling down under the pull of gravity on the longer side.

Other options for non-drapery window coverings can include expensive Venetian-style blinds, which may be of metal, wood or plastic. No Venetian-style paper blinds are known, likely because of the fact that the stresses placed on the sides (and sometimes middle) of the slats by the strings will rip paper slats. There are Roman-style paper blinds, but such products also have shortcomings as temporary window coverings. For example, they are not adjustable horizontally. Portions must be manually clipped together in order to remain in a raised or not-entirely-extended position. Perhaps more importantly, they are susceptible to tearing due to repeated folding and unfolding of the horizontal folds as the blinds are used. Repeated folding and unfolding causes the integrity of the material to weaken at the fold. Since those horizontal folds carry at least some of the weight of the blinds as well as gravitational and other stresses as the blinds are raised and lowered, tearing of the blinds at the folds is common. Further, blinds generally have to be specially made or cut for a window, to ensure that the blinds cover all of the window yet remain less conspicuous and not covering significant parts of the adjacent wall.

However, no products are known in the art which provide a low-cost vertically pleated paper window covering that is easily decoratable to the end-user individual's taste and room's requirements. There exists the need for a size-adaptable, inexpensive, and easy to install temporary window covering that is decoratable and provides a satisfactory appearance.

### SUMMARY

Among other things, a temporary window covering constructed from inexpensive materials, such as paper, is disclosed. The user may compress or expand the covering horizontally, much like an accordion, in order to expose more or less of the window opening. Customization by the user, by altering the size or by decorating the paper, is possible to provide a sturdy, inexpensive covering that meets the taste or style of the user.

Included in this disclosure is a temporary window treatment including a window covering made of paper of a sturdy weight (e.g. approximately 110-120 pound text weight paper or similar weight) and having upper, lower and two side edges, with a series of vertical folds extending from the upper edge to the lower edge The vertical folds are parallel to each other and to the side edges, with each adjacent pair of folds defining a panel between them. The window covering has an upper portion extending from the upper edge toward the lower edge, and has at least a part that is thicker than the paper of the window covering part that is not in the upper portion. The upper portion includes a plurality of holes therethrough, each being between a respective pair of folds. A plurality of ring assemblies is provided, each inserted into a respective one of the holes. A support rod is inserted through the ring assemblies to hold the window covering. The window covering is closed by collapsing the folds to bring two or more of the panels generally together, and is opened by expanding the folds to move two or more of the panels generally apart.

Additionally, a temporary window treatment is disclosed having a window covering made of paper of a sturdy weight (e.g. approximately 110-120 pound text weight paper or similar weight) and having upper, lower and two side edges, with a series of at least five vertical folds extending from the upper edge to the lower edge. The vertical folds are parallel to each other and the side edges, with each adjacent pair of folds defining a panel between them that extend from the upper edge to the lower edge. The window covering also has an upper portion extending from the upper edge toward the lower edge and having at least a part that is thicker than the paper of the window covering part not in the upper portion. The upper portion has a respective hole through each of the panels, each of the holes being between and equidistant from a respective pair of folds. The window covering has a fully collapsed configuration in which each of the panels is contacting its adjacent panel(s) at points other than on their common fold, and in that fully collapsed configuration the holes are in a straight line.

In other embodiments, holes need not be provided in the upper portion of the window covering. Where holes are not provided, spring-loaded clips or clamps can be used to grip the upper portion of the window covering adjacent the upper edge. Such clips or clamps are then connected to a support rod.

Methods are also disclosed, such as a method of making a temporary window treatment including providing a window covering made of paper of a sturdy weight (e.g. approximately 110-120 pound text weight paper or similar weight) and having upper, lower and two side edges, and a series of vertical folds extending from the upper edge to the lower edge. The vertical folds are parallel to each other and to the side edges, and the window covering has an upper portion with a plurality of holes, each being between a respective pair of folds. Such methods can also include customizing the window covering by its user, and hanging the window covering adjacent a window by connecting the holes to a support rod. Customization can include alteration of size (length or width, or by splitting) and decoration, as by painting, drawing, placing stickers, stenciling or the like. The holes can be directly placed on the support rod, or clips, rings, or similar structure can be placed in respective holes and on the rod.

### BRIEF DESCRIPTION OF THE DRAWINGS

FIG. 1 illustrates an embodiment of a temporary window covering utilizing clip ring assemblies to hang the window covering.

FIG. 1A illustrates an embodiment of a temporary window covering according to FIG. 1 of two parts fixed together.

FIG. 2 illustrates an embodiment of a temporary window covering utilizing holes to hang the window covering on a support rod.

FIG. 2A illustrates an embodiment of a temporary window covering according to FIG. 2 utilizing rings or ring assemblies in holes to hang the window covering on a support rod.

FIG. 3A illustrates an embodiment of a temporary window covering having a hemmed portion and holes.

FIG. 3B illustrates a side view of the embodiment of FIG. 3A.

FIG. 4 illustrates an embodiment of a temporary window covering incorporating customized embellishments.

### DETAILED DESCRIPTION OF THE EMBODIMENTS

For the purposes of promoting an understanding of the principles of the disclosure, reference will now be made to the embodiment illustrated in the drawings and specific language will be used to describe the same. It will nevertheless be understood that no limitation of the scope of the claims is thereby intended, such alterations and further modifications in the illustrated device, and such further applications of the principles of the disclosure as illustrated therein, as would normally occur to one skilled in the art to which the disclosure relates are intended to be protected.

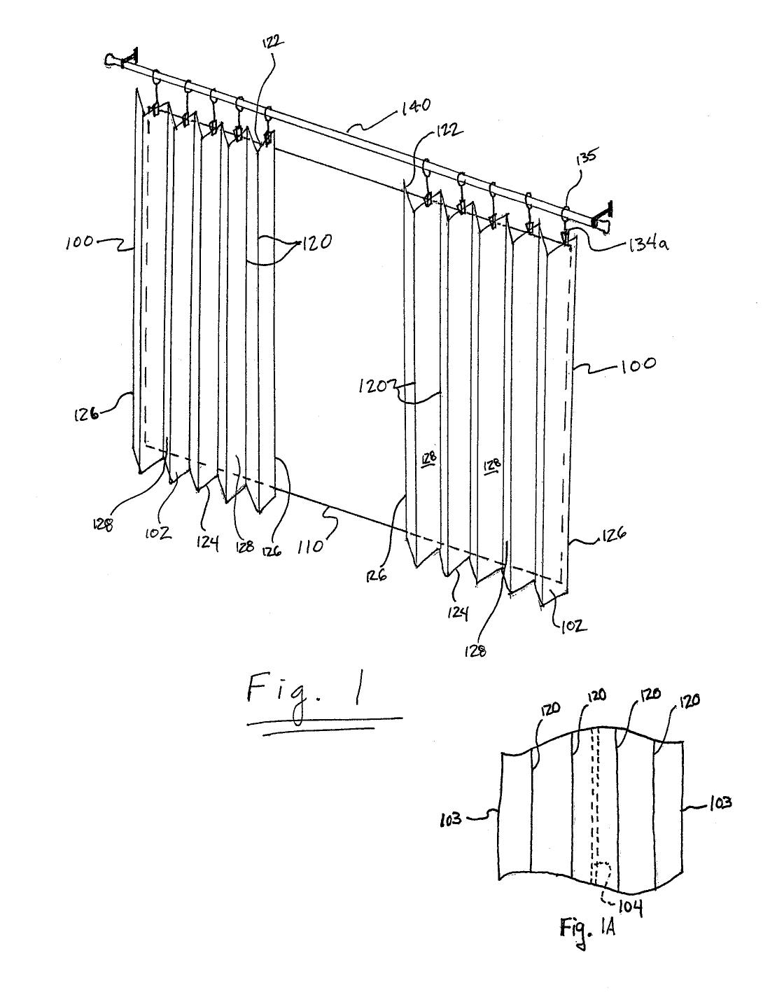

FIG. 1 shows one embodiment of a window treatment including a window covering 100 provided for use in conjunction with window opening 110. Window covering 100 is constructed of a heavy paper or paper-based material, in a single sheet 102 or multiple sheets 103 fixed to each other at a seam 104 (FIG. 1a). One preferred material is paper of approximately 110-120 pound text paper weight, and thicker materials such as card-stock weight may be used but can be more difficult to configure. Such paper is thicker than newsprint and sturdier than both newsprint and other papers and woven fabrics, while allowing easy, defined folding. It is much lighter in weight than standard draperies and many other fabrics, allowing it to be hung in several different ways. It has been found to provide better shielding than newsprint or other thin papers when placed in a window.

The illustrated embodiment of window covering 100 includes a plurality of parallel equidistant vertical folds 120. Each fold extends from an upper edge 122 to a lower edge 124, and in the illustrated embodiment the set of folds 120 are spaced between side edges 126. By “equidistant” is meant that the distances between adjacent folds measured perpendicular to the folds is substantially the same, i.e. the distance measured between each respective pair of adjacent folds is substantially uniform. That distance may also be the distance between the side-most folds and the respective side edges 126. It has been found that a distance of four to eight inches between folds 120 is easy to collapse and expand, is easy to make since the folds do not interfere with each other, and do not intrude too far into a room or interfere with the surface of a window. It may be said that this embodiment of window covering 100 has a series of essentially congruent panels 128, with each panel bounded by one or two folds 120. As seen in the drawings, folds 120 are sharp folds between panels 128, creating a defined line along the fold and a variable angle between the panels. In an embodiment in which the folds are six inches apart from each other and the edges, and the overall width of window covering 100 is four feet, eight panels 128 would be in window covering 100. A typical number of folds is seven, providing a total of eight panels, which has been found to preserve the stretchability or springiness of the covering while providing a good fit and a proper look in a window, without damage to the paper or interference among the folds. Seven folds has been found to be acceptable in a covering of about 36 to about 40 inches in width, as one example. It will be seen that the width of the covering 100 and/or the given window may require a different number of folds and panels. In many embodiments, five or more folds 120 are desirable, in other wider coverings seven or more folds are desirable, and in still other wider coverings nine or more folds are preferable.

The folds 120 enable an end-user to expand or compress window covering 100 horizontally in order to adjust the portion of window opening 110 that is obscured by window covering 100. When compressed, adjacent panels 128 approach each other as the fold 120 between them closes. A maximum compression for a section of window covering 100 is reached when adjacent panels 128 in the section contact each other, or for the entire window covering 100 when every panel 128 contacts its adjacent panel(s) 128. When expanded, folds 120 open and adjacent panels 128 rotate away from each other. A maximum expansion for a section of window covering 100 is reached when adjacent panels 128 in that section are approximately or actually planar with each other, or for the entire window covering 100 when every panel 128 is approximately or actually planar with respect to its adjacent panel(s) 128.

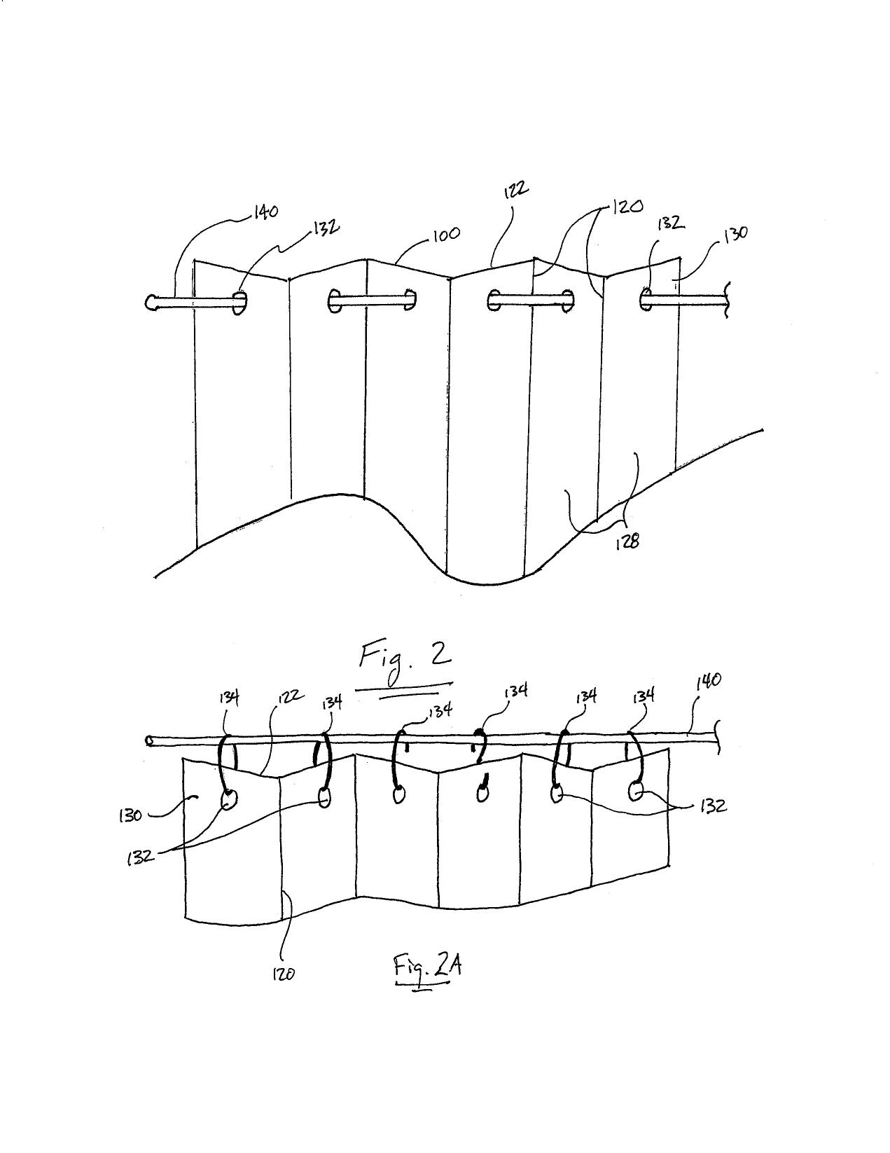

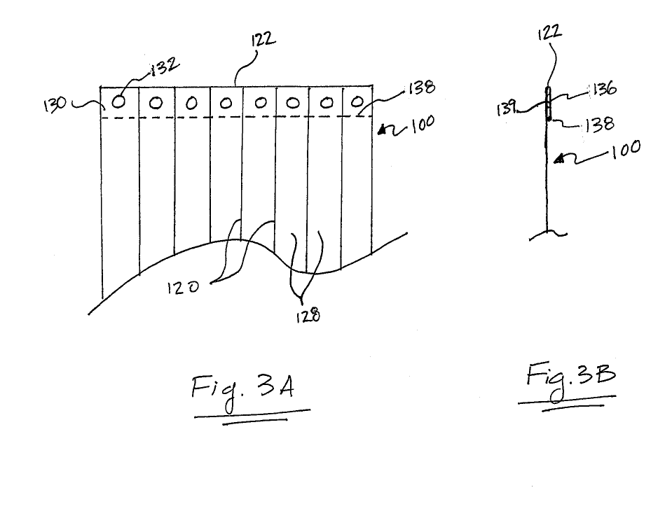

Adjacent to upper edge 122 is an upper portion 130 by which window covering 100 is hung. Upper portion 130, in one embodiment (FIG. 2), is a reinforced or multiple ply section that includes multiple holes 132, through which clip ring assemblies 134 are placed. In one embodiment, upper portion 130 is reinforced by horizontally folding over a portion 136 of the paper, so that the horizontal fold becomes upper edge 122, and the flap of folded-over paper may be glued or otherwise attached to portion 130, as at hem 138 (FIGS. 3A, 3B). Alternatively, a separate length(s) of paper may be attached to the upper portion 130, so that upper portion 130 is thicker compared to the rest of window covering 100.

Holes 132 may be placed at various points along upper portion 130, and good results have been experienced when holes 132 are placed in each panel 128 substantially equidistant from adjacent folds 120, as indicated in FIGS. 2, 2A and 3A. Holes 132 may be reinforced in addition to or instead of a reinforcement of the whole upper portion 130, as described above. Such specific reinforcement of holes 132 can include paper rings around the edges of holes 132, or grommets or other inserts that are thicker than the paper of window covering 100 placed in holes 132. In the illustrated embodiment, each clip ring assembly 134 includes a single ring which extends through an individual hole 132. Clip ring assemblies may include multiple rings, with one ring through an individual hole 132 and additional ring(s) through the ring in the hole. The term “ring” as used herein includes substantially whole-circular structures that are closed or have small gaps, as illustrated, as well as items that are open, S-shaped or less than a full circle or other shape, or that have spring-loaded closures (e.g. a carabiner). Clip ring assemblies 134 are further attached to a support rod 140, providing vertical support, and at the same time, horizontal adjustability for window covering 100.

In other embodiments, holes 132 need not be provided in window covering 100. Instead, spring-loaded clips or clamps 134a (FIG. 1) can be used to grip upper portion 130 adjacent upper edge 122. A clip or clamp 134a has one portion on each side of window covering 100 so that upper portion 130 is pressed between them. Clips or clamps 134a are connected to a support rod 140, in one example by an open or closed ring 135, and a chain, wire or link may connect clamp 134a and ring 135.

Window covering 100 may be pre-manufactured and sold to individuals, or may be constructed initially by the individual. In the former case, the manufacturer can prepare window covering 100 out of a single sheet of relatively heavy paper, as previously noted, or from multiple sheets glued or otherwise fixed together. Such fixing together may preferably be done so that any seam between the sheets is approximately parallel to and between the folds 120, so that stress on the seam can be minimized in the folding process or use of window covering 100. The manufacturer can fold the paper so that it has folds 120, and perhaps additional folds as may be necessary for packaging purposes. Alternatively, the manufacturer can place score lines, printed lines, or other indications on the paper to indicate where the user should make folds 120. The manufacturer similarly can make the reinforced upper portion 130 as described above, or by giving instructions and indications on the paper to the user to do so. Holes 132 are formed by punching or other technique by the manufacturer, or by the individual with instructions and indications from the manufacturer as suggested above. Construction by the individual end-user from scratch includes the same or similar steps as noted above, once the individual has the appropriate raw materials.

Once window covering 100 has been formed by the user, removed from a package or otherwise obtained, the user can adapt it to his or her particular tastes and needs. A single covering 100 may be used to extend across some or all of the width of a window. If window covering 100 is too long or too wide for the window, the user can cut off a bottom portion or a side portion of the window covering 100 to suit the window size and the amount of window (if any) to be unobstructed when the window covering is closed or extended. If the user prefers to have two separate coverings on each side of the window, he or she can provide two different window coverings 100 and hang one on the right and one on the left. Alternatively, if the width of window covering 100 will permit, the user can cut window covering 100 (preferably along a fold) into left and right parts, which may or may not be of equal size. If window covering 100 is not of sufficient size, a second window covering 100 or part of one can be used along with a first (as indicated above) or may be attached to the side or bottom of the first to create a larger window covering.

In addition to adjustment of size, the user may decorate window covering with paint, marker, crayon, stickers, stencils, and/or many other decorating items, styles or techniques. Paper, particularly the sturdy paper preferred for window covering 100, will accept such items and techniques, particularly paint, marker and stickers, much easier and with much better result than with thin paper like newsprint, through which such items can soak or tear, or with woven materials like linens, to which stickers may not stick and other decorations are difficult to apply with aesthetic skill.

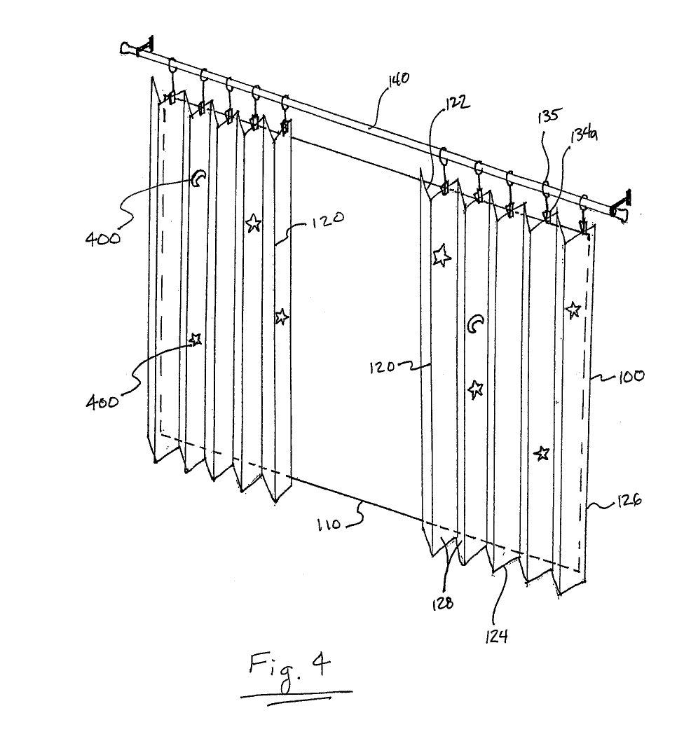

Examples of such decorations or embellishments 400 may be seen in FIG. 4. Embellishments 400 may be the artistic work and design of the user to his or her personal taste, or they may be provided as pre-packaged themed kits. Such themes might include, as non-limiting examples, various sports or sports teams, animals, holiday seasons, hobbies, or school affiliations. Themes might also reflect a user's personal preference for different patterns, such as floral, retro, geometric, alternative art, or natural elements. Furthermore, users may simply color or mark directly on the window covering material itself. Materials for such self-creation, such as paints, stencils, markers or other materials noted above, may be included in a kit with window covering 100 or as a separate adjunct. Embellishments 400, if used on or with window covering 100, provide an enjoyable way for users and their families to share creative expressions, to personalize these inexpensive window treatments, and to easily create new treatments after moving or redecorating. Children may particularly benefit from the opportunity to customize their own room window coverings, without substantial cost to their parents. The extent of design possibilities is virtually limitless.

When window covering 100 is properly sized and decorated, it may be hung from an existing rod 140 or other support above or in a window. If such a support is not in place, one can be installed prior to hanging window covering 100. In the embodiment of FIG. 2A, which uses clip ring assemblies 134, such assemblies are inserted into holes 132 (if not already done by the manufacturer of window covering 100). Rod 140 is inserted through assemblies 134 and placed in its established place in or over the window. In embodiments in which assemblies 134 are open or can be clipped onto rod 140, rod 140 may remain in its established place, and assemblies 134 can be placed on it. In the embodiment of FIG. 1, the sized and decorated window covering 100 is clipped to individual clips or clamps 134a, with one clamp 134a for every other panel 128. Rod 140 is inserted through rings 135 and placed in its established place in or over the window. In both cases, collapsing window covering 100 so that panels 128 generally move together (somewhat like an accordion) unblocks the window, while expanding window covering 100 so that panels 128 move generally apart obstructs the window.

FIG. 2 shows a further embodiment of window covering 100, in which no clip ring assemblies are used. In this embodiment, holes 132 are provided at points between vertical folds 120. Support rod 140 is inserted through holes 132 in an alternating fashion, i.e., so that if one fold 120 is on one side of rod 140, the adjacent fold(s) 120 is on the other side of rod 140. Window covering 100 may be compressed by moving holes 132 together so that adjacent panels 128 move together fully, and it may be expanded to a substantial degree by moving holes 132 apart so that adjacent panels 128 move apart. In this embodiment, a full expansion to the point where panels 128 are substantially or actually planar with each other is not possible in light of the interference of rod 140. This embodiment of window covering 100 has an upper portion 130 that is thicker or reinforced, as described above. Also as noted previously, holes 132 may be reinforced in addition to or instead of a full reinforcement of upper portion 130 to prevent tearing.

It will be seen that window covering 100, provided with the folded-over section 136 and hem 138, has a pocket 139 (FIG. 3B) defined between section 136 and the rest of window covering 100. Pocket 139 can also be used to accommodate a rod 140 or other support, particularly if the section 136, hem 138 and/or the part of window covering 100 that is adjacent section 136 is reinforced. Rod 140 can be inserted through pocket 140 and then placed in its established location on the wall or in the window casing, as described above. However, in this embodiment the opportunity to open window covering 100 will be limited, since rod 140 will interfere with the bending of folds 120 and the moving together of panels 128. Accordingly, this embodiment may be preferable for windows that should remain substantially obstructed. If pocket 139 is intended to accommodate support rod 140, it may not be necessary to include holes 132. However, a window covering 100 that includes both pocket 139 and holes 132 allows for the greatest range of connection to support rod 140, whether via pocket 139, assemblies 134 through holes 132, or clamps 134a clipped onto upper portion 130 of covering 100.

Thus, the window covering may be installed on a standard horizontal drapery or support rod using a variety of methods. Ring clips may simply be attached at points between the vertical folds. In other embodiments, the upper portion of the covering may be reinforced by folding over a strip of material at the top of the covering to create a pocket or hem through which a support rod can be inserted. In a further embodiment, holes can be placed at points between the vertical folds. This enables the covering to hang from a rod inserted through the holes in an alternating fashion, with each subsequent vertical panel of the covering substantially angled from the previous panel when the covering is compressed.

The vertically-pleated configuration of the disclosed window coverings provides increased durability and tear resistance when compared with horizontally-pleated shades, and better aesthetics than newsprint or linens, all while being much more inexpensive than draperies, blinds and other standard treatments. With horizontally-pleated shades, each horizontal fold bears the weight of the covering material below it, including any clips or hardware at the bottom. As such shades are raised and lowered, the horizontal folds become weakened from repetitive folding motion. They are naturally susceptible to tearing because the weight of the shade acts perpendicular to the fold, the weakest part of the shade, and those folds become weaker over time, making them even more susceptible. This limitation is overcome by removing the vertical gravitational stress from the folds, thereby reducing the chance of a rip or tear in the material. The vertical folds in the window covering of the present disclosure are less susceptible to tearing since the folds are not subjected to the perpendicular stress of gravity while hanging.

The use of paper or similar materials in the present invention also allows users to easily and readily customize both the size and appearance of the window covering without a substantial monetary investment. Users may embellish the basic window covering by printing, painting, marking or otherwise directly treating the paper material, or by attaching various types of decorations to embellish the basic material.

Kits may be created which include one or more window coverings 100, clip ring assemblies 134, paints, stickers or other embellishments, instructions or ideas for use, or any subset of these items. Separate embellishment kits may be provided, apart from window coverings 100, with themes corresponding to the user's personal taste.

It will be seen that a number of benefits over existing devices are provided by the above-disclosed embodiments. Not only are they less expensive, easily customizable, and longer-lasting than existing devices, they are easier to hang and use. They also provide additional environmental benefits. The embodiments described above are of a material that can easily be recycled, and can be made of post-consumer content. They also have significant insulating qualities arising from the thickness of the paper and the folded configuration.

While the term “window” and “window covering” has been used throughout this specification, it is noted that the disclosed embodiments will also be useful with glass doors and similar openings.

While the embodiments have been illustrated and described in detail in the drawings and foregoing description, the same is to be considered as illustrative and not restrictive in character, it being understood that only preferred embodiments have been shown and described and that all changes and modifications that come within the spirit of the disclosure are desired to be protected.

I claim:

1. A temporary window treatment, comprising:
a window covering made of paper of approximately 110 to 120 pound text weight, said window covering having an upper edge, a lower edge and two side edges, and a series of vertical folds extending from said upper edge to said lower edge, said vertical folds being parallel to each other and to said side edges, each adjacent pair of said folds defining a panel between them;
said window covering further having an upper portion extending from said upper edge toward said lower edge, said upper portion having at least a part that is thicker than the paper of the part of said window covering not in said upper portion, said upper portion including a plurality of holes therethrough, each of said holes being between a respective pair of said folds;
a plurality of ring assemblies, each of said ring assemblies inserted into a respective one of said holes; and
a support rod inserted through said ring assemblies, wherein said support rod holds said window covering, and said window covering is closed by collapsing said folds to bring two or more of said panels generally together, and said window covering is opened by expanding said folds to move two or more of said panels generally apart.

2. The temporary window treatment of claim 1, wherein said vertical folds are sharp folds creating an angle between adjacent panels.

3. The temporary window treatment of claim 1, wherein the distance measured between a plurality of respective pairs of adjacent folds is substantially uniform.

4. The temporary window treatment of claim 3, wherein said distance between adjacent pairs of vertical folds is about four to eight inches.

5. The temporary window treatment of claim 1, wherein there are an odd number of said vertical folds, so that an even number of said panels results, and wherein said covering has a right and a left end, and said right and left ends point generally in the same direction.

6. The temporary window treatment of claim 1, wherein said thicker part of said upper portion is formed by folding a portion of said covering over on itself to form a hem.

7. The temporary window treatment of claim 6, wherein said portion folded over on itself is glued to itself.

8. The temporary window treatment of claim 1, wherein each said hole is equidistant from its respective pair of folds.

9. The temporary window treatment of claim 1, wherein at least one of said ring assemblies includes a single ring.

10. The temporary window treatment of claim 1, wherein said covering includes at least one score line at one or more locations of said folds.

11. A temporary window treatment, comprising:
a window covering made of paper of approximately 110 to 120 pound text weight, said window covering having an upper edge, a lower edge and two side edges, and a series of at least five vertical folds extending from said upper edge to said lower edge, said vertical folds being parallel to each other and to said side edges, each adjacent pair of said folds defining a panel between them, said panels extending from said upper edge to said lower edge;
said window covering further having an upper portion extending from said upper edge toward said lower edge, said upper portion having at least a part that is thicker than the paper of the part of said window covering not in said upper portion, said upper portion including a respective hole through each of said panels, each of said holes being between and equidistant from a respective pair of said folds;
wherein said window covering has a fully collapsed configuration in which each of said panels is contacting each adjacent panel other than on their common fold, and in that fully collapsed configuration said holes are in a straight line.

12. The temporary window treatment of claim 11, further comprising a plurality of clamps gripping said upper edge, said clamps connected to a support rod.

13. The temporary window treatment of claim 11, further comprising a support rod through said holes in said panels.

14. The temporary window treatment of claim 11, wherein said thicker part of said upper portion is formed by folding a portion of said covering over on itself to form a hem with a pocket through said upper portion along substantially the entire upper edge.

15. The temporary window treatment of claim 14, further comprising a support rod extending through at least part of said pocket.

16. A method of making a temporary window treatment, comprising:
providing a window covering made of paper of approximately 110 to 120 pound text weight, said window covering having an upper edge, a lower edge and two side edges, and a series of vertical folds extending from said upper edge to said lower edge, said vertical folds being parallel to each other and to said side edges, said window covering having an upper portion having a plurality of holes, each of said holes being between a respective pair of said folds;
customizing said window covering by the user of said window covering; and
hanging said window covering adjacent a window by connecting said holes to a support rod.

17. The method of making a temporary window treatment of claim 16, wherein said customizing includes the end-user cutting said covering to fit at least part of a window.

18. The method of making a temporary window treatment of claim 16, wherein said customizing includes the end-user decorating said covering.
